(19) United States
(12) Patent Application Publication
(10) Pub. No.: US 2026/0318375 A1
(43) Pub. Date: Oct. 15, 2026

(54) BRAKE PAD BUSH AND BRAKE DEVICE INCLUDING THE SAME

(71) Applicant: HL MANDO CORPORATION, Gyeonggi-do (KR)

(72) Inventor: Minwoo KIM, Gyeonggi-do (KR)

(73) Assignee: HL MANDO CORPORATION, Gyeonggi-do (KR)

(21) Appl. No.: 19/409,549

(22) Filed: Dec. 4, 2025

(30) Foreign Application Priority Data
Apr. 14, 2025 (KR) 10-2025-0048173

(51) Int. Cl. F16D 65/097; F16D 55/226; F16D 65/18; F16D 121/24; F16D 127/02

(52) U.S. Cl. CPC F16D 65/0971; F16D 55/226; F16D 65/18; F16D 2121/24; F16D 2127/02

(57) ABSTRACT

The brake device comprises: a brake pad having a front side disposed to face a disc so as to be in contact with the disc to generate a braking force; a bracket in which the brake pad is slidably installed; an actuator comprising a piston configured to be displaced in a first direction and presses the brake pad to the disc side during braking; a caliper in which the actuator is installed and configured to be slidably mounted on the bracket; and a brake pad bush configured to be disposed between the brake pad and the piston and is pressed between the brake pad and the piston when the piston is displaced in the first direction and braking is performed, and expands to press the piston in a second direction opposite to the first direction when the braking is released.

### CROSS-REFERENCE TO RELATED APPLICATION

Pursuant to 35 U.S.C. § 119, this application claims the benefit of earlier filing date and right of priority to Korean Patent Application No. 10-2025-0048173, filed on Apr. 14, 2025, the contents of which are all incorporated by reference herein in their entirety.

### TECHNICAL FIELD

The present disclosure relates to a brake pad bush and a brake device including the same, and more particularly to a brake pad bush that presses a piston such that the piston, configured to be displaced in a first direction and presses a brake pad to a disc side during braking, is displaced in a second direction opposite to the first direction when the braking is released, and a brake device including the same.

### RELATED ART

A caliper brake includes a brake pad that generates a braking force by coming in contact with a disc rotating together with a wheel of a vehicle, a bracket in which the brake pad is installed, an actuator including a piston for actuating the brake pad, a caliper in which the actuator is installed, and the like.

During braking, the piston of the actuator is displaced in a first direction in which the piston presses the brake pad to the disc. Accordingly, the brake pad comes in contact with the disc, and a braking force is generated.

When the braking is released, the piston of the actuator must be displaced in a second direction opposite to the first direction. If the piston is not sufficiently displaced in the second direction, the contact between the brake pad and the disc is not completely released, and thus, drag may occur during driving, and durability of the brake, driving performance of the vehicle, and the like may be deteriorated.

### SUMMARY

The purpose of the present disclosure is to provide a brake pad bush that presses a piston such that the piston, configured to be displaced in a first direction and presses a brake pad to a disc side during braking, is displaced in a second direction opposite to the first direction when the braking is released, and a brake device including the same.

The objects of the present disclosure are not limited to the above-described objects, and other objects that are not mentioned will be able to be clearly understood by those skilled in the art to which the present disclosure pertains from the following description.

According to an aspect of the present disclosure, there is provided a brake device including: a brake pad having a front side disposed to face a disc so as to be in contact with the disc to generate a braking force; a bracket in which the brake pad is slidably installed; an actuator including a piston configured to be displaced in a first direction and presses the brake pad to the disc side during braking; a caliper in which the actuator is installed and configured to be slidably mounted on the bracket; and a brake pad bush configured to be disposed between the brake pad and the piston and is pressed between the brake pad and the piston when the piston is displaced in the first direction and braking is performed, and expands to press the piston in a second direction opposite to the first direction when the braking is released.

In the brake device according to an aspect of the present disclosure, the brake pad may have an installation recess on a rear side thereof and the brake pad bush may be seated in the installation recess.

In the brake device according to an aspect of the present disclosure, the brake pad bush may have a hollow shape and the brake pad may include a guide protrusion which protrudes from the installation recess to a rear of the brake pad and is inserted into the hollow of the brake pad bush.

The brake pad bush may include a ring-shaped first bush body; and a ring-shaped second bush body configured to be coaxially connected to the first bush body at an axial end of the first bush body and has an outer diameter smaller than that of the first bush body.

In the brake device according to an aspect of the present disclosure, the first bush body may have a first inner diameter, and the second bush body may have a second inner diameter smaller than the first inner diameter.

In the brake device according to an aspect of the present disclosure, the first bush body may include an inner circumferential inclined portion of which an inner diameter decreases toward the second bush body on the axis.

In the brake device according to an aspect of the present disclosure, the inner circumferential inclined portion may be formed over an entire inner circumferential surface of the first bush body.

In the brake device according to an aspect of the present disclosure, the first bush body may include a first outer circumferential inclined portion having an outer diameter that decreases toward the second bush body on the axis, on an outer circumferential surface of an axial end in contact with the second bush body.

In the brake device according to an aspect of the present disclosure, the second bush body may include a second outer circumferential inclined portion having an outer diameter that decreases as a distance from the first bush body increases on the axis, on an outer circumferential surface of an axial end in contact with the first bush body.

In the brake device according to an aspect of the present disclosure, the second bush body may include a third outer circumferential inclined portion having an outer diameter that decreases as a distance from the first bush body increases on the axis on an outer circumferential surface of an axial end far from the first bush body.

In the brake device according to an aspect of the present disclosure, the first bush body may include a recessed portion recessed radially inward on an outer circumferential surface thereof.

In the brake device according to an aspect of the present disclosure, three recessed portions may be formed at 120-degree intervals along the outer circumferential surface of the first bush body.

In the brake device according to an aspect of the present disclosure, the piston may include a cylindrical piston body; and a piston recess formed to be recessed such that the brake pad bush is inserted into a front surface of the piston body, which faces the brake pad.

According to another aspect of the present disclosure, there is provided a brake pad bush including: a ring-shaped first bush body; and a ring-shaped second bush body configured to be coaxially connected to the first bush body at an axial end of the first bush body and has an outer diameter smaller than that of the first bush body.

In the brake pad bush according to an aspect of the present disclosure, the first bush body may have a first inner diameter, and the second bush body may have a second inner diameter smaller than the first inner diameter.

In the brake pad bush according to an aspect of the present disclosure, the first bush body may include an inner circumferential inclined portion of which an inner diameter decreases toward the second bush body on the axis.

In the brake pad bush according to an aspect of the present disclosure, the first bush body may include a first outer circumferential inclined portion having an outer diameter that decreases toward the second bush body on the axis, on an outer circumferential surface of an axial end in contact with the second bush body.

In the brake pad bush according to an aspect of the present disclosure, the second bush body may include a second outer circumferential inclined portion having an outer diameter that decreases as a distance from the first bush body increases on the axis, on an outer circumferential surface of an axial end in contact with the first bush body.

In the brake pad bush according to an aspect of the present disclosure, the second bush body may include a third outer circumferential inclined portion having an outer diameter that decreases as a distance from the first bush body increases on the axis on an outer circumferential surface of an axial end far from the first bush body.

In the brake pad bush according to an aspect of the present disclosure, the first bush body may include a recessed portion recessed radially inward on an outer circumferential surface thereof.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of a brake device according to an embodiment of the present disclosure.

FIG. 2 is an exploded perspective view of the brake device according to the embodiment of the present disclosure.

FIG. 3 is an exploded perspective view of a brake pad of the brake device according to the embodiment of the present disclosure.

FIG. 4 is a cross-sectional view taken along line A-A′ of FIG. 1 of the brake device according to the embodiment of the present disclosure.

FIG. 5 is a perspective view of a piston of the brake device according to the embodiment of the present disclosure.

FIG. 6 is a perspective view of a brake pad bush according to the embodiment of the present disclosure.

FIG. 7 is a perspective view showing the brake pad bush according to the embodiment of the present disclosure viewed from an angle different from that of FIG. 6.

FIG. 8 is a cross-sectional view taken along line B-B′ of FIG. 6 of the brake pad bush according to the embodiment of the present disclosure.

FIG. 9 is a cross-sectional view showing a state in which the brake pad bush is compressed in the brake device according to the embodiment of the present disclosure.

FIG. 10 is a perspective view showing the brake pad bush in a compressed state according to the embodiment of the present disclosure.

FIG. 11 is a cross-sectional view taken along line C-C′ of FIG. 10 of the brake pad bush according to the embodiment of the present disclosure.

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

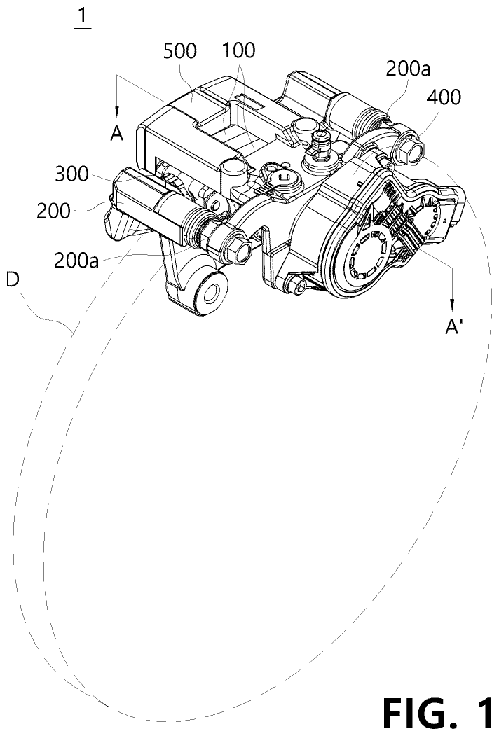

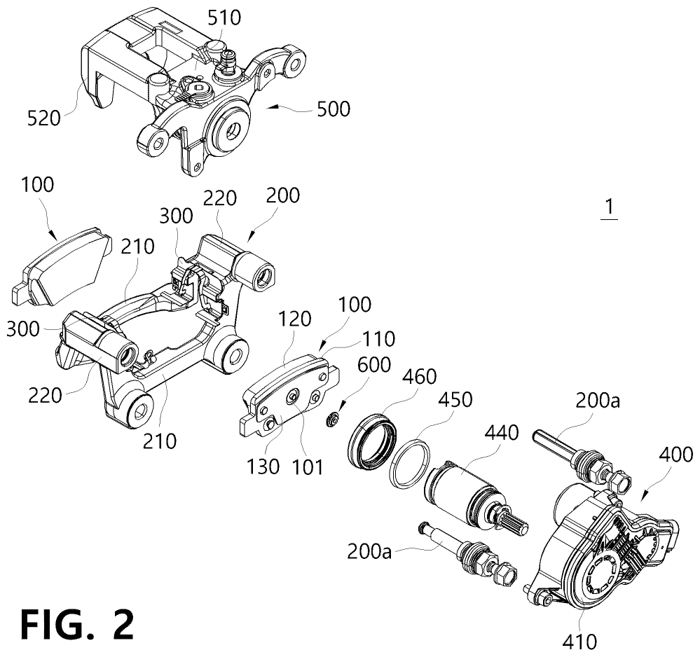

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.
FIG. 1 is a perspective view of a brake device according to an embodiment of the present disclosure. FIG. 2 is an exploded perspective view of the brake device according to the embodiment of the present disclosure.

The brake device 1 according to the embodiment of the present disclosure is installed in a vehicle and generates a braking force by coming in contact with a disc D rotating together with a wheel of the vehicle. The brake device 1 may provide a braking force for decelerating or stopping the vehicle while the vehicle is driving. Also, the brake device 1 may limit the rotation of the disc D while the vehicle is parked so that the state where the vehicle is parked can be maintained.

For example, the brake device 1 may be configured in a caliper type. More specifically, the brake device 1 may have a caliper brake having a parking brake function integrated thereinto. Here, the brake device 1 may operate hydraulically while the vehicle is driving, and may perform the parking brake function electronically by using a motor when the vehicle is parked. Further, the brake device 1 may operate electronically both when braking while the vehicle is driving and when braking while the vehicle is being parked.

Referring to FIGS. 1 and 2, the brake device 1 according to the embodiment of the present disclosure may include a brake pad 100, a bracket 200, a brake pad liner 300, an actuator 400, a caliper 500, and a brake pad bush 600.

The brake pad 100 is disposed to be in contact with one side of the disc D. The brake pad 100 may have a front side disposed to face the one side of the disc D so as to be in contact with the disc D to generate a braking force.

At least one brake pad 100 may be disposed. In the embodiment of the present disclosure, a pair of brake pads 100 are disposed to face each other with the disc D interposed therebetween so as to be in contact with both sides of the disc D, respectively.

When one side shown to be visible among both sides of the disc D shown in FIG. 1 is defined as an inner side of the disc D and the opposite side is defined as an outer side of the disc D, one of the pair of brake pads 100 is disposed to be in contact with the inner side of the disc D, and the other is disposed to be in contact with the outer side of the disc D. In other words, the pair of brake pads 100 may be disposed to face each other while being spaced apart from each other so as to be in contact with the outer side and the inner side of the disc D, respectively.

The brake pad 100 has an installation recess 101 on a rear side thereof. The brake pad bush 600 may be seated in the installation recess 101.

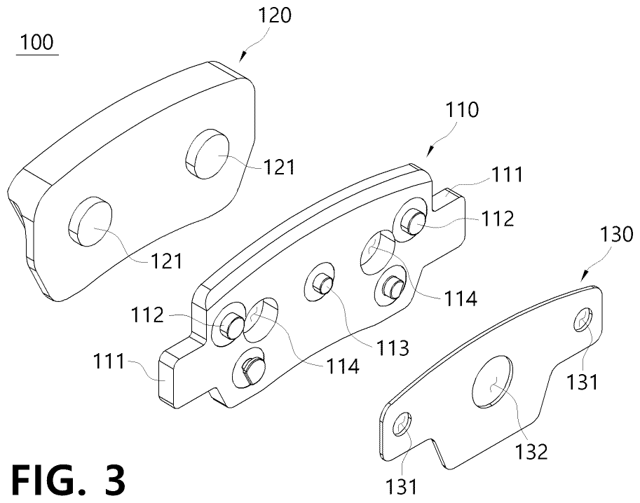

FIG. 3 is an exploded perspective view of the brake pad of the brake device according to the embodiment of the present disclosure. Referring to FIGS. 2 and 3, the brake pad 100 may include a brake pad body 110, a friction member 120, and a rear plate 130.

The brake pad body 110 has a plate shape. The friction member 120 may be coupled to a front surface of the brake pad body 110, and the rear plate 130 may be coupled to a rear surface of the brake pad body 110.

The brake pad body 110 may include a lateral protrusion 111 protruding laterally from both sides thereof, a rear plate fastening protrusion 112 protruding rearward from the rear surface of the brake pad body 110 in order to fasten the rear plate 130, and a guide protrusion 113 protruding rearward from the rear surface of the brake pad body 110 in order to install the brake pad bush 600.

The lateral protrusion 111 is disposed to be slidably inserted into the bracket 200. The brake pad 100 may be slidably disposed in the bracket 200 through the lateral protrusion 111.

A pair of rear plate fastening protrusions 112 may be spaced apart from each other and protrude side by side from one side and the other side of the rear surface of the brake pad body 110, respectively. Also, the guide protrusion 113 may protrude rearward from a central portion of the rear surface of the brake pad body 110.

The brake pad main body 110 may further include a friction member fastening hole 114 penetrating forward and backward for coupling the friction member 120. In the embodiment of the present disclosure, a pair of friction member fastening holes 114 may be formed side by side in such a manner as to be spaced apart from each other.

The friction member 120 comes in contact with the disc D to generate a braking force through friction. The friction member 120 is coupled to the front surface of the brake pad body 110. The friction member 120 includes a brake pad body fastening protrusion 121 protruding rearward from the rear surface. The brake pad body fastening protrusion 121 may be provided to correspond to the positions and numbers of the friction member fastening holes 114.

The rear plate 130 is coupled to the rear surface of the brake pad body 110. The rear plate 130 includes a fastening hole 131 to which the fastening protrusion 112 is through-coupled, and a through-formed installation hole 132 allowing the brake pad bush 600 to be inserted thereinto.

The fastening holes 131 may be formed to correspond to the numbers and positions of the rear plate fastening protrusions 112. Also, the installation hole 132 may be formed in a central portion of the rear plate 130. In a state in which the rear plate 130 is coupled to the rear surface of the brake pad body 110, the installation recess 101 in which the brake pad bush 600 is seated may be formed by the rear surface of the brake pad body 110 and the installation hole 132.

The arrangement of the fastening protrusion and the fastening hole may be changed with regard to the mutual fastening structure of the brake pad body 110, the friction member 120, and the rear plate 130. For example, a protrusion for fastening the friction member 120 may be provided in the brake pad body 110, and a fastening hole for fastening the protrusion may be provided in the friction member 120. Also, a protrusion for fastening to the brake pad body 110 may be provided on the rear plate 130, and a hole may be provided in the brake pad body 110.

The bracket 200 supports the brake pad 100. More specifically, the brake pad 100 is slidably installed in the bracket 200. The bracket 200 may be disposed such that the pair of brake pads 100 may move forward toward the outer side or the inner side of the disc D or move backward with respect to the outer side or the inner side of the disc D.

The bracket 200 may be installed on a knuckle (not shown) of the vehicle. The bracket 200 may be disposed to surround one side of the outer circumference of the disc D. More specifically, a portion of the disc D may enter the inside of the bracket 200 and may be disposed to be rotatable.

Referring to FIG. 2, the bracket 200 includes a bracket body 210 in which the pair of brake pads 100 are installed to be movable forward and backward with respect to the disc D. In the embodiment of the present disclosure, a pair of bracket bodies 210 may be disposed to face each other while being spaced apart from each other such that the pair of the brake pads 100 are respectively disposed. The pair of bracket bodies 210 may be disposed to be spaced apart from each other, and the disc D may be disposed to enter the space therebetween.

The bracket body 210 is formed to support a lower portion and both sides of the brake pad 100. For example, the bracket body 210 may have approximately a U-shape.

The pair of bracket bodies 210 may be connected to each other by a bracket bridge 220. More specifically, the bracket bridge 220 may connect upper ends of both sides of the pair of bracket bodies 210, and a pair of bracket bridges 220 may be disposed side by side. The pair of bracket bodies 210 and the pair of bracket bridges 220 may be integrally formed.

The brake pad liner 300 is disposed between the brake pad 100 and the bracket 200 to slidably support the brake pad 100. Referring to FIG. 2, the brake pad liner 300 may be disposed on the bracket body 210 such that the lateral protrusion 111 of the brake pad body 110 is slidably inserted thereinto.

The actuator 400 presses the brake pad 100 during braking to displace the brake pad 100 to the disc D side. The actuator 400 may be operated mechanically or hydraulically.

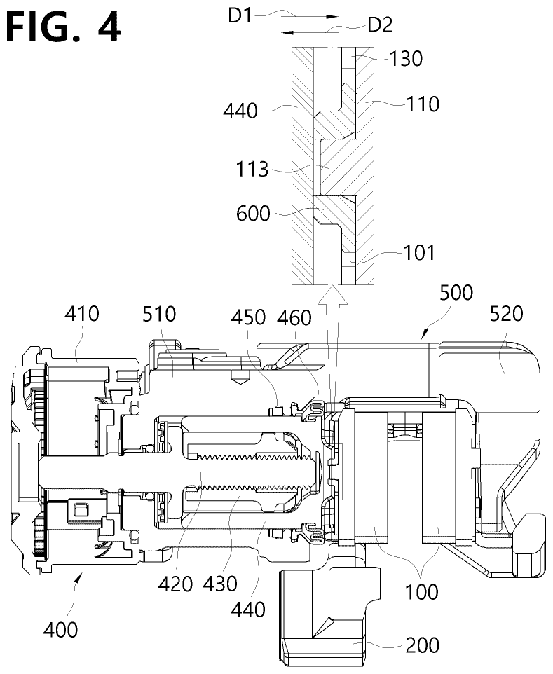

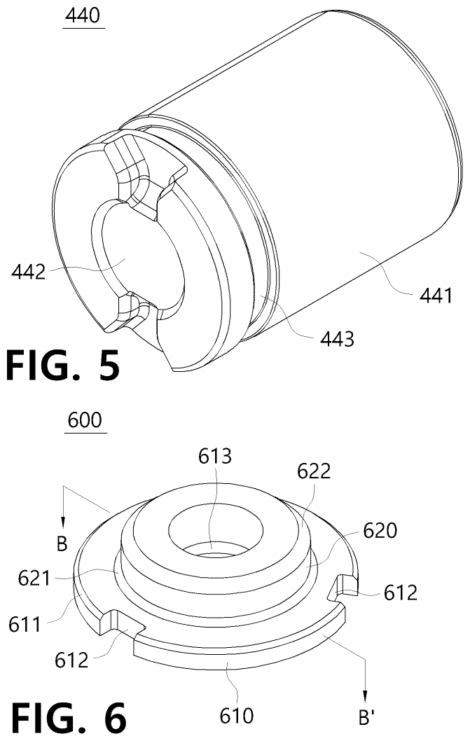

FIG. 4 is a cross-sectional view taken along line A-A′ of FIG. 1 of the brake device according to the embodiment of the present disclosure. FIG. 5 is a perspective view of a piston of the brake device according to the embodiment of the present disclosure.

Referring to FIGS. 4 and 5, the actuator 400 includes a drive system 410, a spindle 420, a spindle nut 430, and a piston 440.

The drive system 410 generates power for pressing the brake pad 100. For example, the drive system 410 may include a motor that generates a rotational force, one or more gears that transmit the rotational force of the motor to the spindle, and the like.

The spindle 420 may receive the rotational force from the drive system 410 and rotate in one direction or the other direction. The spindle 420 is connected to the drive system 410 and rotates. Also, the spindle 420 is engaged with the spindle nut 430.

The spindle nut 430 is engaged with the outer circumferential surface of the spindle 420 and is linearly displaced according to the rotation of the spindle 420. In the embodiment of the present disclosure, the spindle nut 430 may be linearly displaced in a first direction D1 according to the rotation of the spindle 420 in one direction, and may be linearly displaced in a second direction D2 opposite to the first direction D1 according to the rotation of the spindle 420 in the other direction.

The piston 440 is displaced in the first direction D1 and presses the brake pad 100 to the disc D side during braking. The piston 440 may have a cylindrical shape capable of receiving the spindle nut 430 therein.

Referring to FIG. 5, the piston 440 may include a piston body 441, a piston recess 442, and a sealing groove 443.

The piston body 441 has a cylindrical shape. When a side of the piston body 441, which faces the brake pad 100, is referred to as a front side, the piston body 441 may have a cylindrical shape having the closed front side and an open rear side.

The piston recess 442 is formed to be recessed in a front surface of the piston body 441. The piston recess 442 is provided to allow the brake pad bush 600 to be inserted into the front surface of the piston body 441. The piston recess 442 may prevent the brake pad bush 600 from being separated from a regular position during the later-described compression and expansion process of the brake pad bush 600.

The sealing groove 443 is provided for the later-described arrangement of a sealing member. The sealing groove 443 may be formed to be recessed in the outer circumferential surface of the piston body 441 along the circumferential direction.

As the spindle nut 430 is displaced in the first direction D1 or in the second direction D2 within the piston 440 according to the rotation of the spindle 420, the piston 440 may be displaced in the first direction D1 or in the second direction D2 together with the spindle nut 430. With regard to this, the spindle nut 430 and the piston 440 may have a configuration for preventing the rotation of the spindle nut 430.

For example, when braking is performed while the vehicle is driving, hydraulic pressure may be supplied to the inside of the piston 440 so that the piston 440 may move in the first direction D1 by the hydraulic pressure. Meanwhile, when braking is performed while the vehicle is being parked, the spindle 420 is rotated by the power supplied from the drive system 410 so that the piston 440 may be displaced in the first direction D1.

Unlike this, both when braking is performed while the vehicle is driving and when braking is performed while the vehicle is being parked, the spindle 420 is rotated by the power supplied from the drive system 410, and accordingly, the spindle nut 430 is displaced so that the piston 440 may be displaced in the first direction D1.

The actuator 400 may further include a first sealing member 450. The first sealing member 450 may be disposed between the outer circumferential surface of the piston 440 and an inner wall of a caliper body 510 on which the piston 440 is disposed. The first sealing member 450 may seal between the inner wall of the caliper body 510 and the outer circumferential surface of the piston 440. Accordingly, the inside of the piston 440 can be sealed with respect to the outside.

The first sealing member 450 may be formed of a ring made of an elastic material. Also, the first sealing member 450 may be disposed such that, in a state in which the piston 440 is displaced in the first direction D1 and presses the brake pad 100 to the disc D side, the elastic restoring force is applied in a direction in which the piston 440 moves in the second direction D2. Accordingly, this helps the piston 440 return to a position before braking (non-braking position) when the braking is released.

The actuator 400 may further include a second sealing member 460. The second sealing member 460 together with the first sealing member 450 may seal the inside of the piston 440 with respect to the outside. More specifically, the second sealing member 460 may be disposed to seal a gap between the front outer circumferential surface of the piston 440 and the caliper body 510 in which the piston 440 is disposed.

The second sealing member 460 may be seated in the sealing groove 443. The second sealing member 460 may be formed of a ring made of an elastic material. As with the first sealing member 450, the second sealing member 460 may be disposed such that, in a state in which the piston 440 is displaced in the first direction D1 and presses the brake pad 100 to the disc D side, the elastic restoring force is applied in a direction in which the piston 440 moves in the second direction D2.

The caliper 500 is slidably mounted on the bracket 200. Also, the actuator 400 is installed on the caliper 500. The caliper 500 may operate to displace the brake pad 100 in accordance with the actuation of the actuator 400. In other words, the caliper 500 may operate the brake pad 100 while sliding with respect to the bracket 200.

Referring to FIGS. 1 and 2, the caliper 500 may be mounted on the bracket 200 by a pair of sliding pins 200a which pass through the caliper 500 at both sides of the caliper 500 and are inserted into the bracket 200. Here, the caliper 500 may be linearly displaced with respect to the bracket 200 along the sliding pin 200a.

The caliper 500 may include the caliper body 510 and a caliper finger 520.

The caliper body 510 is provided for installation of the actuator 400. That is, the actuator 400 is installed on the caliper body 510. More specifically, the drive system 410 may be installed outside the caliper body 510. Also, the caliper body 510 may provide a receiving space which allows the spindle 420, the spindle nut 430, and the piston 440 to be disposed therein. In other words, the spindle 420, the spindle nut 430, and the piston 440 may be disposed within the caliper body 510.

The caliper finger 520 is connected to the caliper body 510 so as to be in contact with the brake pad 100 disposed to face the outer side of the disc D. When the piston 440 is displaced in the first direction D1 during braking and moves the brake pad 100 disposed to face the inner side of the disc D into contact with the disc D, the caliper body 510 may be slid in the second direction D2 by reaction force. Accordingly, the caliper finger 520 may move the brake pad 100 disposed to face the outer side of the disc D to the outer side of the disc D side.

The brake pad bush 600 is disposed between the brake pad 100 and the piston 440. More specifically, the brake pad bush 600 is disposed between the rear of the brake pad 100 disposed to face the inner side of the disc D among the pair of brake pads 100 and the front of the piston 440.

The brake pad bush 600 may be seated in the installation recess 101 provided on the rear surface of the brake pad 100. Referring to FIGS. 2 and 4, the brake pad bush 600 has a hollow shape, and the guide protrusion 113 protruding rearward from the rear surface of the brake pad 100 may be inserted into the hollow of the brake pad bush 600. Accordingly, the brake pad bush 600 may be stably installed on the brake pad 100.

The brake pad bush 600 may be made of an elastic material capable of compression and expansion. For example, the brake pad bush 600 may be made of a rubber material.

The brake pad bush 600 is compressed between the brake pad 100 and the piston 440 when the piston 440 is displaced in the first direction D1 and braking is performed. Also, the brake pad bush 600 is expanded when the braking is released, and presses the piston 440 in the second direction D2 opposite to the first direction D1. Here, the brake pad 100 refers to one of the pair of brake pads 100, configured to be disposed to face the inner side of the disc D.

The above-described first sealing member 450 and second sealing member 460 have sealing as their main function. Also, if the amount of deformation of the first sealing member 450 and the second sealing member 460 during the braking process is not large, a force for returning the piston 440 is not sufficiently provided when the braking is released.

The brake pad bush 600 is compressed between the brake pad 100 and the piston 440 during the braking process and then is expanded when the braking is released, thereby pressing the piston 440 in the second direction D2 opposite to the first direction D1, so that the reliable return of the piston 440 is induced. Accordingly, a drag phenomenon of the vehicle can be reliably prevented.

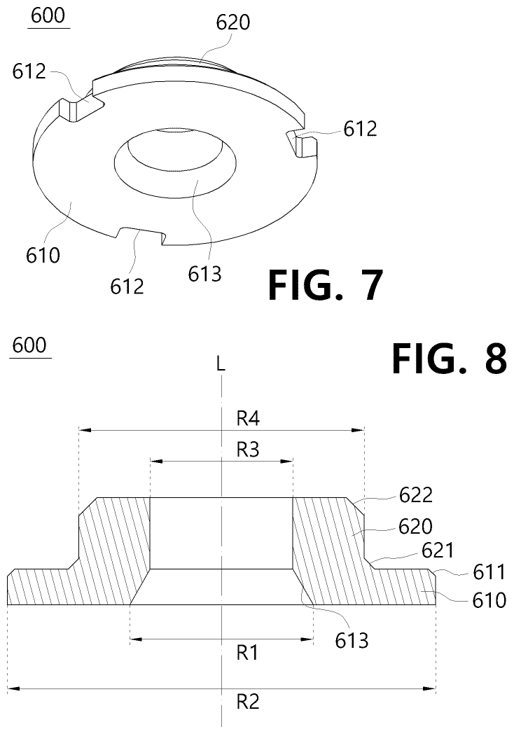

FIG. 6 is a perspective view of the brake pad bush according to the embodiment of the present disclosure. FIG. 7 is a perspective view showing the brake pad bush according to the embodiment of the present disclosure viewed from an angle different from that of FIG. 6. FIG. 8 is a cross-sectional view taken along line B-B′ of FIG. 6 of the brake pad bush according to the embodiment of the present disclosure. The brake pad bush 600 shown in FIGS. 6 to 8 is in an uncompressed state without being compressed.

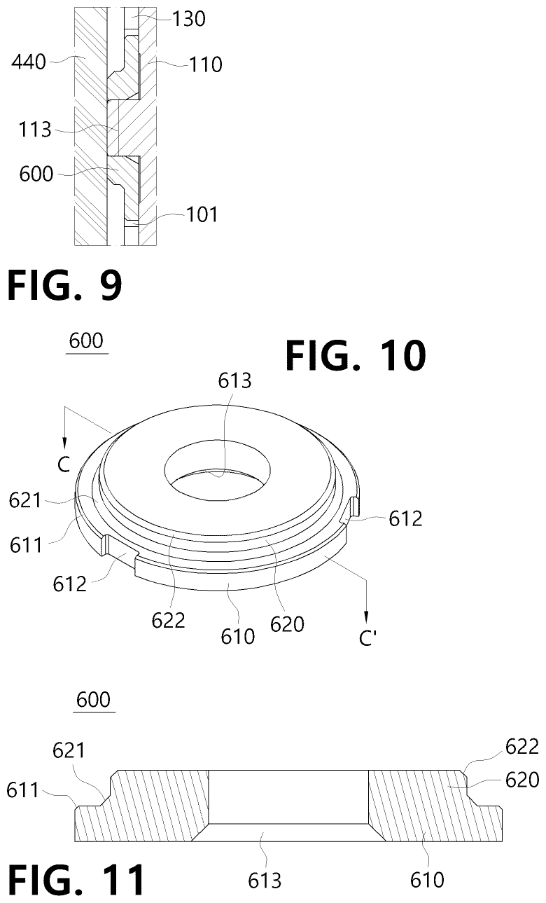

FIG. 9 is a cross-sectional view showing a state in which the brake pad bush is compressed in the brake device according to the embodiment of the present disclosure. FIG. 10 is a perspective view showing the brake pad bush in a compressed state according to the embodiment of the present disclosure. FIG. 11 is a cross-sectional view taken along line C-C′ of FIG. 10 of the brake pad bush according to the embodiment of the present disclosure.

Referring to FIGS. 6 to 11, the brake pad bush 600 includes a first bush body 610 and a second bush body 620.

The first bush body 610 has a ring shape. The second bush body 620 is coaxially connected to the first bush body 610 at an axial end of the first bush body 610 and has an outer diameter smaller than that of the first bush body 610.

In other words, the first bush body 610 and the second bush body 620 are disposed to extend each other along the same axis L. The first bush body 610 has a shape having an enlarged diameter with respect to the second bush body 620, and the second bush body 620 has a shape having a reduced diameter with respect to the first bush body 610.

As shown in FIG. 4, the first bush body 610 may be inserted into the installation recess 101 of the brake pad 100 and seated on the rear side of the brake pad 100, and the second bush body 620 may be disposed to face the front side of the piston 440.

Referring to FIG. 8, the first bush body 610 may have a first inner diameter R1, and the second bush body 620 may have a second inner diameter R3 smaller than the first inner diameter R1. Also, as described above, the first bush body 610 may have a first outer diameter R2, and the second bush body 620 may have a second outer diameter R4 smaller than the first outer diameter R2.

The first bush body 610 may include a first outer circumferential inclined portion 611 having an outer diameter that decreases toward the second bush body 620 on the axis L, on an outer circumferential surface of the axial end in contact with the second bush body 620.

The second bush body 620 may include a second outer circumferential inclined portion 621 having an outer diameter that decreases as a distance from the first bush body 610 increases on the axis L, on an outer circumferential surface of the axial end in contact with the first bush body 610.

The second bush body 620 may further include a third outer circumferential inclined portion 622 having an outer diameter that decreases as a distance from the first bush body 610 increases on the axis L on an outer circumferential surface of the axial end far from the first bush body 610.

The above-described configuration of the first bush body 610 and the second bush body 620 allows the piston 440 to be displaced in the first direction D1 during braking, and allows the compression to be stably performed when the brake pad bush 600 is compressed between the piston 440 and the brake pad 100 disposed to face the inner side of the disc D. Also, when the braking is released, the brake pad bush 600 is expanded to efficiently press the piston 440 in the second direction D2.

Also, the first bush body 610 may include a recessed portion 612 recessed radially inward on the outer circumferential surface thereof. A plurality of recessed portions 612 may be formed in the first bush body 610.

In the embodiment of the present disclosure, three recessed portions 612 are formed at 120-degree intervals along the outer circumferential surface of the first bush body 610. Further, the shape, position, number, and the like of the recessed portions 612 are not limited by the embodiment of the present disclosure.

The depression 612 allows the brake pad bush 600 to be easily expanded in the radial direction when the brake pad bush 600 is compressed between the brake pad 100 and the piston 440. More specifically, when the first bush body 610 is compressed in the axial direction and is expanded radially outward, the recessed portion 612 is pushed upward in the radially outward direction and the circumference of the recessed portion 612 is expanded, so that the first bush body 610 can be easily deformed.

Also, the recessed portion 612 allows the brake pad bush 600 to be stably gripped by manufacturing equipment during the manufacturing process of the brake device 1. For example, when the brake device 1 is manufactured by a robot, the recessed portion 612 may improve the gripping stability of the brake pad bush 600 by the robot.

Meanwhile, the first bush body 610 may include an inner circumferential inclined portion 613 of which an inner diameter decreases toward the second bush body 620 on the axis. In the embodiment of the present disclosure, the inner circumferential inclined portion 613 may be formed over the entire inner circumferential surface of the first bush body 610.

When the brake pad bush 600 is expanded and presses the piston 440 in the second direction D2 when the braking is released, a repulsive force may be generated in the first direction D1. Accordingly, the brake pad 100 spaced apart from the disc D may be pressed to the disc D side. This may act as a factor that may cause a drag phenomenon while the vehicle is driving.

When the brake pad bush 600 is compressed and then expanded, the inner circumferential inclined portion 613 induces most of the force to be generated in the second direction D2. This will be described in detail as follows.

The inner circumferential inclined portion 613 induces the compression of the brake pad bush 600 to be performed in a direction from the second bush body 620 to the first bush body 610. That is, the inner circumferential inclined portion 613 induces the compression of the brake pad bush 600 to be performed in such a manner that the second bush body 620 is recessed toward the first bush body 610.

When the compression state of the brake pad bush 600 is released and the brake pad bush 600 is expanded, the inner circumferential inclined portion 613 induces the restoration of the brake pad bush 600 to be performed in a direction from the first bush body 610 to the second bush body 620. In other words, the inner circumferential inclined portion 613 allows the brake pad bush 600 to be expanded as the second bush body 620 recessed toward the first bush body 610 side is pushed in the second direction D2. Accordingly, when the brake pad bush 600 is expanded, the direction of the force may be induced in the second direction D2.

As described above, the brake pad bush 600 presses the piston 440 in the second direction D2 when braking is released, thereby allowing the piston 440 to return to a non-braking position. Accordingly, the drag of the brake device 1 can be reduced.

Also, in the embodiment of the present disclosure, the brake pad bush 600 focuses the direction of the force generated when the brake pad bush 600 is expanded, on the second direction D2, that is, the piston 440 side, through the inner circumferential inclined portion 613, thereby preventing the brake pad 100 from being displaced in the braking direction by the brake pad bush 600.

According to the above configuration, in the brake pad bush and the brake device including the same according to embodiment of the present disclosure, the brake pad bush is disposed between the brake pad and the piston of the actuator. The brake pad bush is compressed during braking, and is expanded when the braking is released. The brake pad bush presses the piston to induce the piston to be displaced to a non-braking position, thereby preventing drag while the vehicle is driving and improving durability of the brake and driving performance of the vehicle.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A brake device comprising:
a brake pad having a front side disposed to face a disc so as to be in contact with the disc to generate a braking force;
a bracket in which the brake pad is slidably installed;
an actuator comprising a piston configured to be displaced in a first direction and presses the brake pad to the disc side during braking;
a caliper in which the actuator is installed and configured to be slidably mounted on the bracket; and
a brake pad bush configured to be disposed between the brake pad and the piston and is pressed between the brake pad and the piston when the piston is displaced in the first direction and braking is performed, and expands to press the piston in a second direction opposite to the first direction when the braking is released.

2. The brake device of claim 1, wherein the brake pad has an installation recess on a rear side thereof and the brake pad bush is seated in the installation recess.

3. The brake device of claim 2, wherein the brake pad bush has a hollow shape and the brake pad comprises a guide protrusion which protrudes from the installation recess to a rear of the brake pad and is inserted into the hollow of the brake pad bush.

4. The brake device of claim 1, wherein the brake pad bush comprises:
a ring-shaped first bush body; and
a ring-shaped second bush body configured to be coaxially connected to the first bush body at an axial end of the first bush body and has an outer diameter smaller than that of the first bush body.

5. The brake device of claim 4, wherein the first bush body has a first inner diameter, and the second bush body has a second inner diameter smaller than the first inner diameter.

6. The brake device of claim 4, wherein the first bush body comprises an inner circumferential inclined portion of which an inner diameter decreases toward the second bush body on the axis.

7. The brake device of claim 6, wherein the inner circumferential inclined portion is formed over an entire inner circumferential surface of the first bush body.

8. The brake device of claim 4, wherein the first bush body comprises a first outer circumferential inclined portion having an outer diameter that decreases toward the second bush body on the axis, on an outer circumferential surface of an axial end in contact with the second bush body.

9. The brake device of claim 4, wherein the second bush body comprises a second outer circumferential inclined portion having an outer diameter that decreases as a distance from the first bush body increases on the axis, on an outer circumferential surface of an axial end in contact with the first bush body.

10. The brake device of claim 4, wherein the second bush body comprises a third outer circumferential inclined portion having an outer diameter that decreases as a distance from the first bush body increases on the axis on an outer circumferential surface of an axial end far from the first bush body.

11. The brake device of claim 4, wherein the first bush body comprises a recessed portion recessed radially inward on an outer circumferential surface thereof.

12. The brake device of claim 11, wherein three recessed portions are formed at 120-degree intervals along the outer circumferential surface of the first bush body.

13. The brake device of claim 1, wherein the piston comprises:
a cylindrical piston body; and
a piston recess formed to be recessed such that the brake pad bush is inserted into a front surface of the piston body, which faces the brake pad.

14. A brake pad bush comprising:
a ring-shaped first bush body; and
a ring-shaped second bush body configured to be coaxially connected to the first bush body at an axial end of the first bush body and has an outer diameter smaller than that of the first bush body.

15. The brake pad bush of claim 14, wherein the first bush body has a first inner diameter, and the second bush body has a second inner diameter smaller than the first inner diameter.

16. The brake pad bush of claim 14, wherein the first bush body comprises an inner circumferential inclined portion of which an inner diameter decreases toward the second bush body on the axis.

17. The brake pad bush of claim 14, wherein the first bush body comprises a first outer circumferential inclined portion having an outer diameter that decreases toward the second bush body on the axis, on an outer circumferential surface of an axial end in contact with the second bush body.

18. The brake pad bush of claim 14, wherein the second bush body comprises a second outer circumferential inclined portion having an outer diameter that decreases as a distance from the first bush body increases on the axis, on an outer circumferential surface of an axial end in contact with the first bush body.

19. The brake pad bush of claim 14, wherein the second bush body comprises a third outer circumferential inclined portion having an outer diameter that decreases as a distance from the first bush body increases on the axis on an outer circumferential surface of an axial end far from the first bush body.

20. The brake pad bush of claim 14 wherein the first bush body comprises a recessed portion recessed radially inward on an outer circumferential surface thereof.
